(19) United States
(12) Patent Application Publication
(10) Pub. No.: US 2026/0200434 A1
(43) Pub. Date: Jul. 16, 2026

(54) Authorized Operation of Vehicles

(71) Applicant: Invisible Holdings, LLC, Reno, NV (US)

(72) Inventors: Jackie Tucker, Santa Cruz, CA (US); Andrew Lee Van Valer, Reno, NV (US)

(73) Assignee: Invisible Holdings, LLC, Reno, NV (US)

(21) Appl. No.: 19/372,028

(22) Filed: Oct. 28, 2025

Related U.S. Application Data
(63) Continuation-in-part of application No. 18/745,321, filed on Jun. 17, 2024.
Application No. 18/745,321 is a continuation-in-part of application No. 17/697,642, filed on Mar. 17, 2022, now abandoned.
Application No. 17/697,642 is a division of application No. 16/830,792, filed on Mar. 26, 2020, now Pat. No. 11,299,127.

(51) Int. Cl. B60R 25/30; B60R 25/20

(52) U.S. Cl. CPC B60R 25/30; B60R 25/20; B60R 25/2063; B60R 2325/106

(57) ABSTRACT

A system for enabling a candidate driver to start a vehicle has a key fob with signal generators and an antenna, is configured to generate an encrypted indicating, elements of the key fob powered from a common battery through individual dedicated normally-open (NO) switches, has a microprocessor and a data repository, wireless communication circuitry; and a (NO) switch positioned in the circuitry in a manner that prevents, when open, generation of the encrypted signal indicating presence of the key fob, and a smartphone executing a mobile application enabling a candidate driver to log in to the mobile application. The candidate driver logs in, the mobile application determines if the candidate driver is authorized to start and operate the vehicle, and if so, transmits a signal to the microprocessor to close the NO switch positioned to prevent, when open, generation of the encrypted signal indicating presence of the key fob.

### CROSS-REFERENCE TO RELATED DOCUMENTS

The present patent application is a continuation-in-part (CIP) of co-pending non-provisional application Ser. No. 18/745,321, filed Jun. 17, 2024, which is a CIP of U.S. non-provisional application Ser. No. 17/697,642, filed Mar. 17, 2022, which is a divisional of U.S. non-provisional application Ser. No. 16/830,792, filed Mar. 26, 2020 now issued as U.S. Pat. No. 11,299,127 on Apr. 12, 2022. Disclosure of parent applications is incorporated herein entirety at least by reference.

### BACKGROUND OF THE INVENTION

### 1. Field of the Invention

The present invention is in the technical area of vehicle controls and pertains more particularly to a system for enabling specific persons to operate a particular vehicle.

### 2. Description of Related Art

It is well known that there are many circumstances wherein certain individuals should not operate motor vehicles. For example, a person known to have a serious drinking problem, and who may have had serial DUI arrests, should not drive, for that person's sake and for the sake of the general public. Certainly, a person inebriated or under influence of other mind-altering chemicals should not drive. The same is true for a person suffering from some serious level of dementia, or from some other physical disability that would make it dangerous for that person to drive. In families, an older person having lost the necessary vision, coordination, or attention to safely drive a vehicle should not be allowed to do so.

A variety of solutions have been implemented in the general area of who should not drive. In some circumstances, often predicated by a court order, a person who has a severe problem with alcohol may be required by order of a court to install a breathalyzer device which is integrated with ignition circuitry of the person's vehicle, to be able to activate the ignition to start the vehicle. But it is well known in the art that public and private efforts to prevent unsafe drivers from driving are often largely ineffectual. As a single example, a person required to have a breathalyzer device on his or her vehicle may simply rent, or even steal a vehicle, and still be a hazard on the public streets and roads.

It is known in the art of telematics to provide a dongle that plugs into the OBD port of a vehicle, and to communicate with the dongle through a cellular telephone app, via short-range wireless protocol, to both retrieve data from the vehicle's computer system and to operate some functions of the vehicle, such as rolling the windows down, for example.

So, a rather straight-forward way of preventing one person from operating the vehicle might be to disable the ignition in the presence of that person, or if that person attempts to operate the vehicle. This is what is done, for example, with the breathalyzer apparatus.

With experience with these sorts of systems it has become clear that there is often difficulty with identification, among other problems. If the goal is to prevent a person who has a physical or mental issue that makes it unsafe for that person to operate a vehicle from operating a vehicle, for example, it is necessary that the apparatus in the vehicle recognize that person. And there may other problems with disabling the ignition, which may become disabled while the automobile is being driven on a busy freeway.

What is needed in the art is a system that enables a vehicle to be started and driven by a specific person qualified to operate the vehicle, rather than disabling the vehicle for a specific person who may not be competent to operate the vehicle.

### BRIEF SUMMARY OF THE INVENTION

In an embodiment of the invention a system for enabling a candidate driver to start a vehicle is provided, comprising a key fob comprising a plurality of signal generators each coupled to a common antenna and configured to generate an encrypted RF signal at a specific frequency, one of the encrypted signals being a signal recognizable by the vehicle's computer system as presence of the key fob, the generators, except the generator providing the signal recognizable by the vehicle's computer system as presence of the key fob, powered from a common battery through individual dedicated normally-open (NO) switches, a microprocessor executing first coded instructions from a data repository coupled to the microprocessor, wireless communication circuitry coupled to the microprocessor; and a (NO) remotely-operable switch positioned in the circuitry in a manner that prevents, when open, generation of the encrypted signal indicating presence of the key fob, and a smartphone executing a mobile application generating an interactive interface on a touchscreen display of the smartphone at least enabling a candidate driver to log in to the mobile application. The candidate driver logs in to the mobile application, the mobile application determines if the candidate driver is authorized to start and operate the vehicle, and if so, transmits a signal to the microprocessor via the wireless communication circuitry, causing the microprocessor to close the NO remotely-operable switch positioned in a manner to prevent, when open, generation of the encrypted signal indicating presence of the key fob, closing the switch signaling the vehicle's computer system to enable the starter pushbutton such that the candidate driver may start the vehicle.

In one embodiment the individual, dedicated NO switches to individual generators are physical push button switches, the NO remotely-operable switch positioned in a manner to prevent, when open, generation of the encrypted signal indicating presence of the key fob, is positioned in a conductor from a positive terminal of the battery, such that, when open no elements are powered, and when closed by the microprocessor the pushbutton switches are powered, the encrypted signal indicating presence of the key fob is powered, and the candidate driver may individually activate any one of the generators powered through the pushbuttons. Also in one embodiment the individual, dedicated NO switches to individual generators are physical push button switches, the NO remotely-operable switch positioned in a manner to prevent, when open, generation of the encrypted signal indicating presence of the key fob, is positioned in a conductor between the generator of the encrypted signal indicating presence of the key fob and the antenna, such that when open the signal that a key fob is present is not transmitted, but the candidate driver may activate other signals through the physical pushbutton switches. In one embodiment the individual, dedicated NO switches to individual generators are remotely operable by the microprocessor, there are no physical pushbutton switches and all signal generation is initiated by the mobile app executing on the smartphone. And in one embodiment the key fob is placed in the vehicle and is stationary, rather than being carried by the candidate driver.

In one embodiment the key fob is a relatively flat enclosure holding the key fob elements, and has an adhesive on one side enabling the key fob to be mounted to a surface in or on the vehicle. Also, in one embodiment the surface is on the vehicle's dashboard or a center console. In one embodiment the mobile app generates interactive interfaces on a touchscreen display of the smartphone, and one such display comprises virtual pushbuttons dedicated to sending signals to the microprocessor of the key fob causing individual ones of the remotely operable switches to close, such that the candidate driver, through interacting with the virtual pushbuttons in the display, causes locking and unlocking and other automobile functions to occur. In one embodiment determination of whether the candidate driver is authorized to start and operate the vehicle is accomplished by the mobile application administering tests to the candidate driver, determining of the candidate driver is impaired physically or mentally. In one embodiment determination of whether the candidate driver is authorized to start and operate the vehicle is accomplished by the mobile application checking to see if the candidate driver's identification is in a list of authorized candidate drivers for the specific vehicle. And in one embodiment a list of authorized drivers is downloaded by the mobile application from an internet-connected server using a unique vehicle identification retrieved from the data repository coupled to the microprocessor in the key fob.

In another aspect of the invention a method for enabling a candidate driver to start a vehicle is provided, comprising providing a key fob comprising a plurality of signal generators each coupled to a common antenna and configured to generate an encrypted RF signal at a specific frequency, one of the encrypted signals being a signal recognizable by the vehicle's computer system as presence of the key fob, the generators, except the generator providing the signal recognizable by the vehicle's computer system as presence of the key fob, powered from a common battery through individual dedicated normally-open (NO) switches, a microprocessor executing first coded instructions from a data repository coupled to the microprocessor, wireless communication circuitry coupled to the microprocessor; and a (NO) remotely-operable switch positioned in the circuitry in a manner that prevents, when open, generation of the encrypted signal indicating presence of the key fob, executing a mobile application on a smartphone, generating an interactive interface on a touchscreen display of the smartphone at least enabling a candidate driver to log in to the mobile application, logging in to the mobile application by the candidate driver determining by the mobile application if the candidate driver is authorized to start and operate the vehicle, and, if it is determined the candidate driver is authorized, causing the microprocessor to close the NO remotely-operable switch positioned in a manner to prevent, when open, generation of the encrypted signal indicating presence of the key fob, closing the switch signaling the vehicle's computer system to enable the starter pushbutton such that the candidate driver may start the vehicle.

In one embodiment of the method the individual, dedicated NO switches to individual generators are physical push button switches, comprising positioning the NO remotely-operable switch positioned in a manner to prevent, when open, generation of the encrypted signal indicating presence of the key fob, in a conductor from a positive terminal of the battery, such that, when open, no elements are powered, and when closed by the microprocessor the pushbutton switches are powered, the encrypted signal indicating presence of the key fob is powered, and the candidate driver may individually activate any one of the generators powered through the pushbuttons. Also, in one embodiment the individual, dedicated NO switches to individual generators are physical push button switches, comprising positioning the NO remotely-operable switch positioned in a manner to prevent, when open, generation of the encrypted signal indicating presence of the key fob, in a conductor between the generator of the encrypted signal indicating presence of the key fob and the antenna, such that when open the signal that a key fob is present is not transmitted, but the candidate driver may activate other signals through the physical pushbutton switches. And in one embodiment the individual, dedicated NO switches to individual generators are remotely operable by the microprocessor, there being no physical pushbutton switches, comprising initiating all signal generation by the mobile app executing on the smartphone.

In one embodiment the method comprises placing the key fob stationary in the vehicle, rather than being carried by the candidate driver. In one embodiment the key fob is a relatively flat enclosure holding the key fob elements, and has an adhesive on one side, comprising mounting the key fob by the adhesive to a surface in or on the vehicle. In one embodiment the method comprises mounting the key fob to the vehicle's dashboard or to a center console. In one embodiment the method comprises the mobile app generating interactive interfaces on a touchscreen display of the smartphone, and one such display comprises virtual pushbuttons dedicated to sending signals to the microprocessor of the key fob causing individual ones of the remotely operable switches to close, such that the candidate driver, through interacting with the virtual pushbuttons in the display, causes locking and unlocking and other automobile functions to occur.

In one embodiment the method comprises determining whether the candidate driver is authorized to start and operate the vehicle is accomplished by administering by the mobile application tests to the candidate driver, determining of the candidate driver is impaired physically or mentally. In one embodiment the method comprises determining whether the candidate driver is authorized to start and operate the vehicle by the mobile application checking to see if the candidate driver's identification is in a list of authorized candidate drivers for the specific vehicle. And, in one embodiment the method comprises downloading a list of authorized drivers by the mobile application from an internet-connected server using a unique vehicle identification retrieved from the data repository coupled to the microprocessor in the key fob.

### BRIEF DESCRIPTION OF THE SEVERAL VIEWS OF THE DRAWINGS

FIG. 1 is a diagram illustrating a system in one embodiment of the present invention.

FIG. 2 is a flow diagram illustrating a procedure for starting the subject vehicle of FIG. 1.

FIG. 3 is a diagram illustrating a system in an alternative embodiment of the present invention.

FIG. 4 is a flow diagram depicting steps in operation of the system of FIG. 3.

FIG. 5 illustrates a system with a compound cylindrical SmartFuse.

FIG. 6 illustrates a system with a compound cylindrical SmartFuse without a fuse element.

FIG. 7 illustrates a system with a dummy fuse and functional elements in an external package.

FIG. 8A illustrates a SmartFuse with blade connectors in Prior Art.

FIG. 8B shows the SmartFuse of FIG. 8A showing internal elements in Prior Art.

FIG. 8C illustrates a SmartFuse with internal elements in an embodiment of the invention.

FIG. 8D Illustrates a SmartFuse in two parts in an embodiment of the invention,

FIG. 8E illustrates the SmarFuse of FIG. 8D showing internal elements in an embodiment of the invention.

FIG. 8F illustrates the SmartFuse of FIG. 8E separated into two component parts in an embodiment of the invention.

FIG. 9 is a generalized diagram of a keyfob in the prior art.

FIG. 10A illustrates a key fob in an embodiment of the invention,

FIG. 10B illustrates a key fob in another embodiment of the invention

FIG. 11 is a diagram of a mobile device in an embodiment of the invention.

FIG. 12 is a diagram of a mobile device in another embodiment of the invention.

FIG. 13A is a side elevation view of a specialized key fob in an embodiment of the invention.

FIG. 13B is a plan view of the key fob of FIG. 13A in an embodiment of the invention.

FIG. 14 is a diagram of an interactive interface on a smartphone in an embodiment of the invention.

### DETAILED DESCRIPTION OF THE INVENTION

After consideration of the difficulty of recognizing particular people and disabling the ignition of a vehicle for operation by those particular people, the present inventors decided that a far better approach might be to enable the ignition for specific people rather than disabling the ignition for a specific person. Some vehicles may be operated nearly always by just one specific person. But in that event, the principal operator of that vehicle may wish to be able to loan the vehicle to another for a limited time. There are also situations wherein an owner and operator of a vehicle may want to take advantage of, for example, a valet parking circumstance, wherein it will be necessary for a person other than the principal owner/operator to drive the vehicle. These sorts of circumstances will have to be accommodated in any system according to embodiments of this invention.

Most vehicles may be owned by, or registered to one particular person, but may not be exclusively operated by that person. It is, in fact, rather rare for any single vehicle to be operated exclusively by just one person. For example, in a family situation there may be more than one vehicle, and different vehicles may on occasion be shared. There may be two or more drivers of any particular vehicle over a period of time.

The inventors have spent considerable time discussing the requirements of a system that may operate by enabling a vehicle to be started and operated only by a person authorized to do so, but that will not start for a person not authorized to start or operate the vehicle. The inventors thus developed a preliminary specification for such a unique system, comprising a few specific apparatuses, as follows:
(A) Apparatus (A) comprises computerized apparatus integrated with other circuitry of a subject vehicle, such as ignition circuitry, the apparatus capable of preventing the vehicle from being started or operated by anyone, unless the candidate driver may be recognized as an authorized driver by the computerized apparatus in the vehicle. Ignition circuitry is common to vehicles powered by internal combustion power plants, but electrically powered vehicles typically also have an Off/On switch to enable the vehicle to be operated.

In one implementation apparatus (A) may be a smart apparatus with what amounts to a normally open (NO) contact in the electrical line that brings voltage to the vehicle's key switch, the NO contact operable by a processor executing coded instructions from a data repository that may also store data. This smart apparatus in one embodiment might be original equipment integrated into computerized circuitry of the vehicle, and in another embodiment may be an add-in apparatus that may be installed in existing vehicles.

Controlling voltage to the keyed ignition switch is not the only means of controlling whether a vehicle may be started and operated. There are other means described below.
(B) Apparatus (B) comprises computerized apparatus capable of identifying a candidate driver as an authorized driver, and of commanding apparatus (A) to allow the candidate driver to start and operate the vehicle.

Apparatus (B) will comprise in most embodiments input elements whereby a candidate driver may interact with the apparatus, a data repository that may also store coded instructions as well as data, and a processor, such as a microprocessor, that may execute the coded instructions in accordance with inputs from the input elements. The input elements may be physical switches or buttons in some implementations but may be displayed virtual inputs on a touchscreen in other implementations. The invention is taught in several different embodiments.

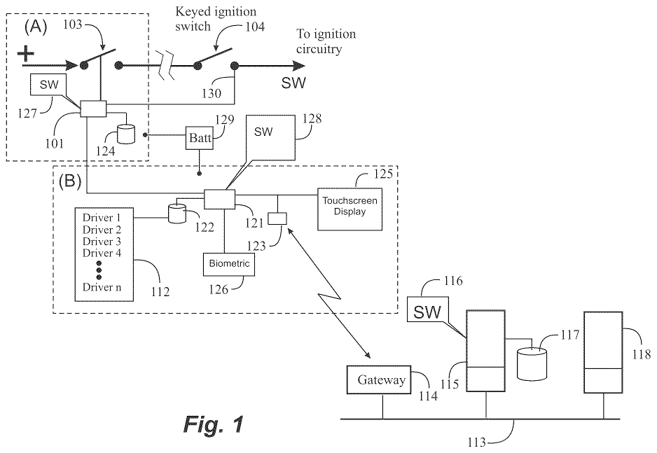

FIG. 1 illustrates an embodiment in which the necessary features and functions are integrated into the original equipment of a vehicle. Apparatus (A) in this embodiment comprises a computerized subsystem that has a normally open contact 103 in an electrical line that feeds the keyed ignition switch 104 (or equivalent) in a subject vehicle. If normally open contact 103 is open, the vehicle can not be started or operated.

In some embodiments of the invention the equivalent of a keyed ignition switch may be a push-button ignition enabled wirelessly by a keyfob, which is a device specific to the automobile, emitting a wireless signal that enables the ignition just as a key might do in a keyed ignition system. Operation in a push-button system may be the same as in a keyed ignition.

Normally open contact 103 is controlled by microprocessor 101 coupled to a data repository 124. Being a computerized apparatus there is also a date and time clock incorporated, and processor 101 may execute software 127.

Apparatus (B) in this example of an original equipment implementation comprises a second microprocessor 121 coupled to a second data repository 122. The skilled artisan will understand that in this embodiment processors 101 and 121 may actually operate as one processor, but in this description are depicted as two separate processors. The same may be said for the two data repositories. Processor 121 may execute software 128 from repository 122. A battery component 129 is shown as providing power to both apparatus (A) and apparatus (B). This may be a line from the vehicle battery before either contact 103 or keyed switch 104. This may in some instances be a separate battery, and there may be an off/on switch, not shown, that may be used to initiate voltage to both apparatus (A) and apparatus (B). It is necessary that apparatus (A) and apparatus (B) have operating voltage for the electronic components before the vehicle is enabled to start.

In this example data repository 122 stores a list of drivers who are authorized to operate the subject vehicle. The list may comprise just one, or a considerable plurality of authorized drivers. In this example processor 121 may present one or more interactive interfaces on a touchscreen in the dash of the subject vehicle, and there may virtual inputs on the touchscreen whereby a driver may input data or commands to the system, and the system may display information on the touchscreen for the driver. There may be a biometric input 126, such as, for example, a fingerprint scanner, that may be a part of the touchscreen or may be separate from the touchscreen.

In this example there is a wireless circuit 123 as a part of apparatus (B) enabled to communicate on a cellular network, and to establish communication through a gateway 114 to Internet backbone 113, which represents all of the connectivity and sub-networks of the well-known Internet. Internet connected server 115 executing software 116 and coupled to a data repository 117 represents in this embodiment a server hosted by an enterprise that may interact with apparatus (B) in the subject vehicle. Server 118 represents a plurality of Internet connected servers that may be hosted by private and public enterprises.

In operation in this example the list 112 of drivers who are authorized to operate the subject vehicle may be edited through server 115 by persons operating Internet connected computer platform through a browser. To do so the person seeking to edit list 112 in any vehicle must be authenticated as a person entitled to do so. Such entitlement may be controlled in a number of ways, such as by members of a family, authorized operatives of an enterprise that may, for example, be responsible for operating a fleet of trucks, taxis or other vehicles, or by perhaps different government entities.

In some embodiment microprocessor 101 may need to know when the vehicle is operating, and when the vehicle stops operating, that is when the driver opens the keyed ignition switch to stop the engine. In some embodiment there may be feedback 130 from the ignition side of the keyed ignition switch that indicates to microprocessor 101 the state of the ignition. This is not in all cases just a conductor as indicated but might be signals of another sort to convey the information of the ignition state.

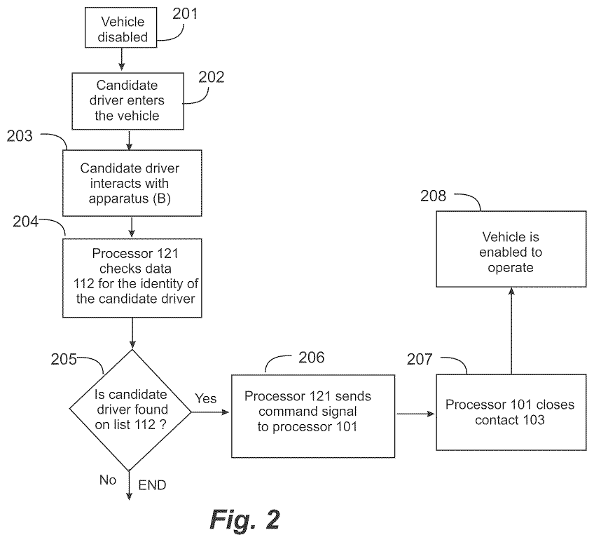

FIG. 2 is a flow diagram illustrating a process of a candidate driver entering the subject vehicle of FIG. 1 and endeavoring to start the vehicle. At step 201 the vehicle is disabled. At step 202 the candidate driver enters the vehicle at the driver's position. At step 203 the candidate driver interacts with apparatus (B). If the candidate driver is not an authorized driver of the subject vehicle, he or she may not be aware of any necessity to interact with apparatus (B). In this case, contact 103 will not be closed, and the vehicle will not start, even with a proper keyed interaction with ignition switch 104.

If the candidate driver is an authorized driver, or believes herself to be, she will be aware of the need to interact with apparatus (B). It may be that Apparatus (A) and (B) have operating voltage. In some cases, it will be needed to flip an “on” switch. In some cases, the act of touching biometric input 126 will cause voltage to apply, or touching touchscreen 125 will do so. In any case, it is necessary that the candidate driver identify herself to the system. This may happen through a fingerprint scan at input 126, and a fingerprint scan at touchscreen 125. There may also be some other biometric input, like an iris scan, for example. In one implementation touchscreen 125 may display input fields for a username and a password.

At step 204, after the candidate driver has identified herself through input, processor 121 checks data list 112 for the identity of the candidate driver. If, at step 205, the candidate driver is not found on the list, the process ends, and the vehicle cannot be started. If, at step 205, the candidate driver is found on the list, at step 206 processor 121 sends a command signal to processor 101 to close contact 103. Now the vehicle may be started with keyed switch 104.

In one embodiment processor 101 senses when keyed ignition switch 104 opens, that is, when the driver elects to turn off the ignition. In response processor 101 also opens contact 103, requiring that the process of FIG. 2 be repeated for the car to be started again. In the circumstance that the driver is identified by a biometric input, the process is very quick, and not a burden.

The inventors recognize that there may be instances where an authorized driver may want to loan the vehicle to another, or they may be some urgent need for a driver other than an authorized driver to start and operate the vehicle. In one embodiment there may be an interactive interface displayed on touchscreen display 125 through which an authorized driver may close contact 103 for a selected period of time, such as, for example, 24 hours, allowing an unauthorized driver to start and operate the vehicle during that time period. In another circumstance there may be inputs in an interactive interface by which an authorized driver may elect to keep contact 103 closed for an elected period of time each time that the process to close contact 103 is successfully completed.

Referring now to Internet connected server 115 and recalling that the system according to FIGS. 1 and 2 is a system integrated into the vehicle's computer circuitry in manufacture, there may be a variety of ways that services may be provided by software 116 executing at server 115. In one embodiment data repository 112 may store an identity of the subject vehicle such that communication between server 115 and the subject vehicle may only be enabled if the ID is known to server 115. Under this circumstance, if a person were to purchase a vehicle operating according to an embodiment of this invention as an original equipment embodiment, the purchaser might register with server 115, verify ownership of the vehicle, perhaps by cooperation of the manufacturer or seller of the vehicle, the identification for that vehicle may be entered to enable communication between server 115 and the subject vehicle through wireless circuitry 123. One service might be an ability, as described briefly above, to edit the list of authorized drivers for the subject vehicle. The identification for the vehicle might be a digital version of the well-known VIN for the vehicle.

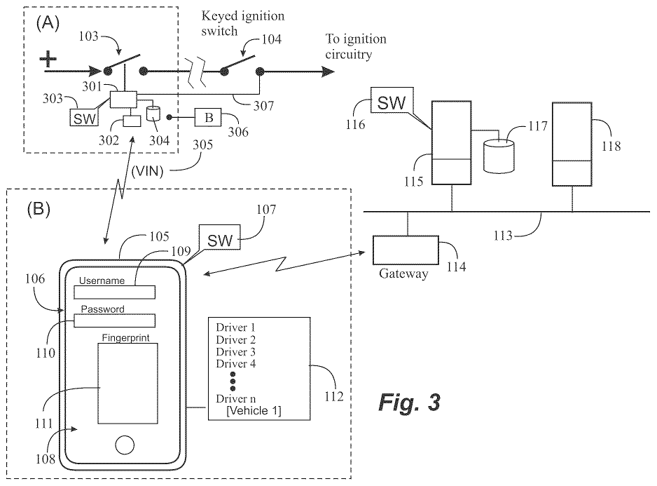

FIG. 3 is a diagram depicting an embodiment of the present invention especially suited for an aftermarket situation. This is a system that may be installed in just about any existing vehicle that has a keyed start switch 104, or a pushbutton ignition enabled by a keyfob, as described briefly above. Apparatus (A) in this example is a unit that has an input and an output terminal such that it may be connected to battery voltage on one side and to input for the keyed switch 104 on the other side. Apparatus (A) thus becomes a condition for positive battery voltage to be connected to the keyed switch or pushbutton.

Apparatus (A) in this example comprises a microprocessor 301 coupled to a data repository 304 and executing software (SW) 303. The microprocessor is also connected to a wireless communication circuitry 302, that is enabled to pair to remote but nearby devices, such as Bluetooth™ devices. Bluetooth™ however is not a limitation, as there are other near field systems that might be used.

A battery component 306 is shown as providing power to apparatus (A). This may be a separate battery for the purpose, perhaps rechargeable, or may a line from the vehicle battery before either contact 103 or keyed switch 104. It is necessary that apparatus (A) has operating voltage for the electronic components.

In one embodiment apparatus (A) may be a unit enclosed in a protected casing, enabled to be attached to a vehicle firewall or any other accessible surface, and then connected to battery voltage and to the keyed switch, which should then not be connected to another input, so apparatus (A) is the only input to the keyed switch.

Apparatus (B) in this example is provided by a smartphone 105 (or other mobile device, such a pad device, having a touchscreen display 106 and a data repository 112. In this embodiment the smartphone has a processor, not shown, executing software 107, which may include an application specific to this invention, providing interactive interfaces on touchscreen display 106, one of which may be interface 108 illustrated. In this embodiment smartphone 105 communicates on a cellular network, and may couple to the Internet network, represented by backbone 113, through a gateway 114.

Data repository 112, coupled to the processor in the smartphone, stores one or more lists of authorized drivers, here indicated by Driver 1 through Driver n, associated with a particular vehicle, listed her as vehicle 1. It should be understood that the driver listings in the data repository may not be for just one specific vehicle but may be recorded and stored for a plurality of vehicles, and each specific vehicle may have one or more than one authorized driver.

With apparatus (A) in place and connected in a vehicle as shown, a candidate driver may enter the vehicle at the driver's position to start and operate the vehicle. In this example, if the candidate driver does not have a smartphone executing the specific application required, that driver cannot start the vehicle, because contact 103 is normally open, and cannot be closed to enable keyed switch 104 unless a certain procedure takes place with smartphone 105. It may be assumed that candidate drivers who are properly authorized to start and operate the specific vehicle shown will be aware that the smartphone executing the app is necessary.

When the candidate driver enters the vehicle at the driver's position the near-field wireless system of the smartphone will pair with wireless apparatus 302 automatically, if it has been previously paired and set for automatic pairing. Otherwise, the candidate will have to initiate pairing through the settings facility of the smartphone, after which the pairing may be automatic going forward.

Pairing by smartphone 105 with wireless apparatus 302 is necessary, but not sufficient to close contact 103. The app that presents interactive interface 108 must be executing. But the app executing is also not a sufficient condition. The candidate driver also must be logged into the app, which he or she may do through interactive interface 108, by, for example, entering the correct username in field 109 and password in field 110. Alternatively, there may be a biometric input like fingerprint scanner 111 or an equivalent authentication scheme.

With a candidate driver in place, the smartphone paired with apparatus 302, and the candidate logged into the executing application, processor 301 executing SW 303 causes a vehicle identification 305 to be communicated to the smartphone app. This will be a digital value unique to the specific vehicle and may be a digital representation of the well-known vehicle identification number (VIN). This may be accomplished in different ways. The VIN may just be broadcast as long as apparatus (A) is powered or may be broadcast momentarily in response to a query from smartphone 105 running the application. In any case, upon receiving the VIN, and being aware of the identity of the driver logged into the application, the application checks the list 112 of authorized drivers in the data repository for the specific vehicle having the received VIN. If the candidate driver is on the list, the app communicates a specific command to processor 301 in apparatus (A) through wireless apparatus 302, and in response, processor 301 closes contact 103, enabling the candidate driver to operate keyed switch 104 and start the vehicle.

In some embodiments, as described above microprocessor 301 may need to know when the vehicle is operating, and when the vehicle stops operating, that is, when the driver opens the keyed ignition switch, or equivalent, to stop the engine. In some embodiment there may be feedback 307 from the ignition side of the ignition switch that indicates to microprocessor 101 the state of the ignition. This is not in all cases just a conductor as indicated but might be signals of another sort to convey the information of the ignition state.

As described for the original equipment embodiment above, processor 301 may close contact 103 for a selected time period, and there may be configuration interfaces enabling the authorized driver to configure different operating programs for apparatus (A) to account for a need for such as valet parking, loaning the vehicle to trusted drivers, and other situations.

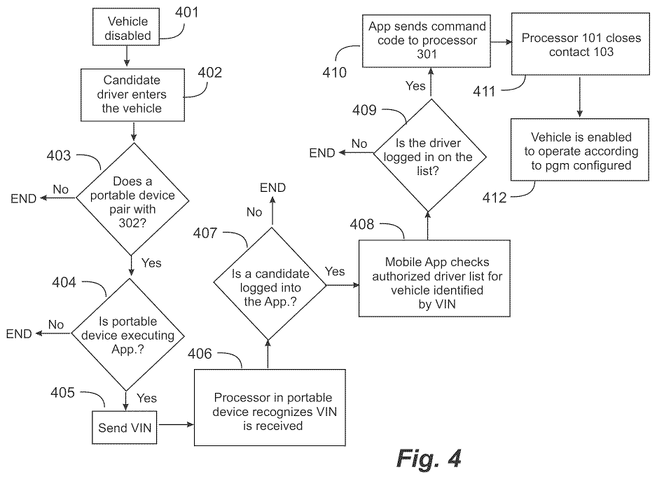

FIG. 4 is a flow diagram illustrating steps in a process for enabling the specific vehicle in FIG. 3 to be started and operated. At step 401 the vehicle is disabled, with contact 103 open. At step 402 a candidate driver enters the vehicle at the driver's position. At step 403 processor 301 determines if a portable device pairs with wireless apparatus 302. If not, the process ends. If Yes, control goes to step 404, where it is determined whether the portable device is executing a specific application unique to the invention. If No, the process ends. If Yes, control goes to step 405, and processor 301 causes the stored VIN for the vehicle to be communicated to the App being executed by the portable device. At step 406 the App. recognizes that the VIN is received.

At step 407 it is determined whether a candidate is logged into the App. If not, the process ends. If Yes, control goes to step 408. At step 408 the App. checks the authorized driver list stored for the specific vehicle identified by the VIN. At step 409 it is determined whether the candidate driver logged into the App. is on the list. If not, the process ends. If Yes, control advances to step 410, and the App. sends a command code to processor 301 by way of wireless apparatus 302. Processor 301 closes contact 103 in response at step 411. At step 412 the specific vehicle is enabled to operate according to whatever program may have been configured.

In one embodiment of the invention, rather than a cellular telephone, which is a convenience, an authorized driver might have a dongle, the dongle having an input for identification, such as a fingerprint, and short-range wireless circuitry to pair with control unit 101. The dongle in this case would be enabled to receive the ID number, to check authorization, and to send the correct command input to processor 301 to cause the switch 103 to close. In this example, the dongle provides a two-factor authentication, being something the driver possesses and something the driver is.

As briefly described above, there may be a web presence integrated with systems according to embodiments of the invention. Internet backbone 113 is illustrated to represent all the connections, networks and interconnections in the Internet network. A gateway 114 is illustrated as connected to Internet 113 and in wireless communication with mobile device 105. A server 115 is shown connected to the Internet and executing software (SW) 116. Server 115 is coupled to a data repository 117. A third-party server 118 is illustrated as also connected to the Internet.

In one embodiment of the invention server 115 provides a web site to which persons may register to participate in services provided relative to a system to enable persons to operate vehicles that may be equipped to operate according to embodiments of the invention. Users may register in the system provided by server 115 as is well-known in the art, such as by creating a Username and a Password. Registered persons may log in and avail themselves of services provided.

One service provided by server 115 may enable persons to set up a family cooperative unit wherein family members may confer and decide on driving privileges for specific vehicles that may be personal property of and may be registered to different members sf the family group. In this service vehicle ID numbers and authorized drivers may be associated, and this information may be communicated to individual mobile apps used by the family members. As authorizations change, server 115 may communicate changes to apparatus such as smartphones of candidate drivers, and in some instances a candidate driver may discover he or she can no longer operate a certain vehicle.

The inventors in the present case are aware that implementation of some embodiments of the invention and their use might have some legal ramifications. For example, one motivation for this invention is a need for a way to deal with the social and family problem of senior citizens gradually losing the physical and cognitive abilities to safely drive in public places. It is known that this is typically a very gradual evolution, and there is no definitive standard to say one particular person has passed from being a safe driver to being a driver putting himself and others at an unacceptable risk.

Many families go through the process of trying to deal with an older father or grandfather, for example, who has had an increasing problem, resulting in fender-benders, narrow escapes, tickets for reckless driving, and so forth. It is an exceptional person who has a clear realization that he or she has reached a point that everyone would be safer if that person no longer drove. It is more often the case that the subject has a blind spot, and a level of denial. No one looks forward to the suspension or removal of driving privileges. Privacy issues and the like, however, are not technical issues, and have no bearing on patentability. The family group enabled as described above, to act in concert to authorize drivers of shared family vehicles, may certainly control a family member's ability to operate a vehicle, if that vehicle is equipped according to an embodiment of this invention.

### Anti-Theft Issues

The system in embodiments of the present invention has further advantages, it seems. For example, a vehicle equipped with a control unit according to the invention may be more difficult to steal. Many ways that vehicles are stolen by jumping the keyed ignition switch are now ineffective, because jumping the keyed ignition switch will not start the vehicle. Vehicles with electric motors may also be equipped with systems according to this invention, as long as there is a keyed switch to start the vehicle and operate the electric motors.

### Truck and Auto Fleets

Managers of trucking firms, taxi companies and other enterprises having fleets of vehicles that may be operated by employees of the enterprise may equip their vehicles with systems according to embodiments of this invention, and effectively control which employees are enabled to operate which vehicles.

### Insurance Companies

Insurance providers may certainly prorate cost of insurance depending on existence of systems according to embodiments of the invention in vehicles insured and use by the insured.

A skilled person will understand that the examples and embodiments described are entirely exemplary, and not limiting to the scope of the invention. The functionality described for elements of the invention, and for systems of elements, may be accomplished in a variety of ways. For example, controlling voltage to the keyed ignition switch is not the only means of controlling whether a vehicle may be started and operated. The voltage can also be disrupted (low voltage) in areas other than the keyed ignition switch to control starting the vehicle. Some of these areas are: The engine control unit, a park/neutral switch, a fuel pump, starter control, security system, crank angle/position, and others. These will not disrupt the major power systems of the car—alarm, clock settings, etc. The invention in some embodiments may be enabled by placing a connection/relay/switch/fuse (turn on/off) between two critical non-dangerous connections and intercepting the current to the sensor that won't allow a car to start.

### A SmartFuse Implementation

In embodiments of the invention described thus far above an apparatus (A) in a candidate vehicle comprises a CPU coupled to a data repository and coupled to circuitry in the vehicle such that a contact controlled by the CPU must be closed to enable the vehicle to start and run. In one aftermarket embodiment this is described and illustrated as an apparatus that may be installed in the vehicle placing a controlled normally open (NO) contact between the vehicle's battery and the keyed ignition switch or starting pushbutton. An apparatus (B) in these embodiments is in one instance a smartphone executing an application that has access to a data store with identities of drivers authorized to operate the vehicle. Further, in the embodiment of FIG. 3 a feedback line 307 is used to indicate to CPU 301 whether the vehicle is running or not. This is necessary in embodiments interrupting voltage to the ignition circuitry, so the system may be reset to require identification to restart.

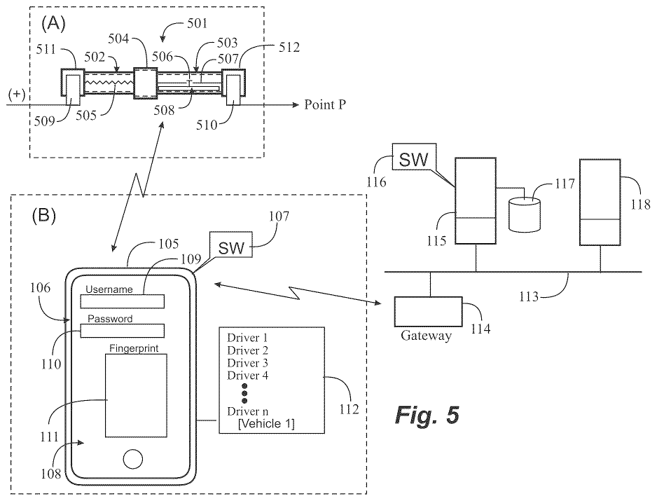

FIG. 5 illustrates yet another embodiment of the invention, specific to the aftermarket circumstance. In FIG. 5 apparatus (B) is the same in form and similar in function as illustrated and described in in regard to FIG. 3, and the functions of apparatus (B) with internet servers 115 and 118 is the same as described in regard to FIG. 3. In this new embodiment an existing fuse box in a vehicle is leveraged to provide the functions of Apparatus (A).

It is well-known that nearly all vehicles have one or more fuse boxes with fuses installed to protect circuitry in the vehicle. It is also well-known that fuses in automotive applications follow certain standards in capacity, diameter and physical dimensions. In this embodiment a compound SmartFuse 501 is provided that has two distinct portions 502 and 503. Portion 502 has a fuse element 505 that is adapted to burn out at or near a specific direct current. Portion 503 has an electrical conductor of a size to easily carry the fuse current without failure and is interrupted by a normally open (NO) contact 506 controlled by a computerized element 508, which comprises a CPU, a data repository, and wireless communication circuitry as described for apparatus (A) in regard to FIG. 3.

Referring again to FIG. 5, SmartFuse 501 has a conductive end cap 511 that that connects to filament 505 and also snaps on one end to a clip 509 coupled to vehicle battery voltage, and has a conductive end cap 512 that connects to line 507 and also snaps into a clip 510 conventionally providing battery voltage to circuitry in the vehicle (referred to as point P), that must have battery voltage for the vehicle to be started and operated. There may be a variety of candidates for point P, such as, for example, a relay that activates (provides power to) the starter solenoid. As different fuses in different automobiles are implemented in different ways, a user might be able to, with reference to manufacturer's info, pick a fuse to replace with the Smartfuse that will serve to keep the car idle unless contact 506 is closed.

Portions 502 and 503 have common diameter end pieces, common to fuses, and are made to be joined lengthwise with a connector 504 to exhibit the combined length of a standard fuse to fit in the fuse box. In practice a user may determine a single conventional fuse in the fuse box of the vehicle that provides voltage and current in particular to a component that must have voltage to start the vehicle, such as a relay activating the starter solenoid, which must be operated to start the vehicle, and may simply remove that fuse and replace it with the SmartFuse, having a rating equal to the fuse removed. The vehicle is now equipped to operate with Apparatus (B) as described above to limit operators to those approved to operate the vehicle. The skilled person will understand that the starting sequence for the automobile is of a certain short period each time a user attempts to start the vehicle, so it is only necessary to close contact 506 for a specific relatively period of time. In one embodiment the CPU in computerized element 508 closes contact 506 for five minutes each time a candidate driver is identified as authorized to start the vehicle. After five minutes contact 506 is opened again, and there is no need for feedback to indicate that the vehicle is running or not.

Referring again to FIG. 5, the SmartFuse in this embodiment is adapted to imitate the length and diameter of the fuse it is intended to replace, and the CPU, data repository and other electronic components, such as the NO contact, are all necessarily in the SmartFuse, but this is not a necessary limitation to the invention.

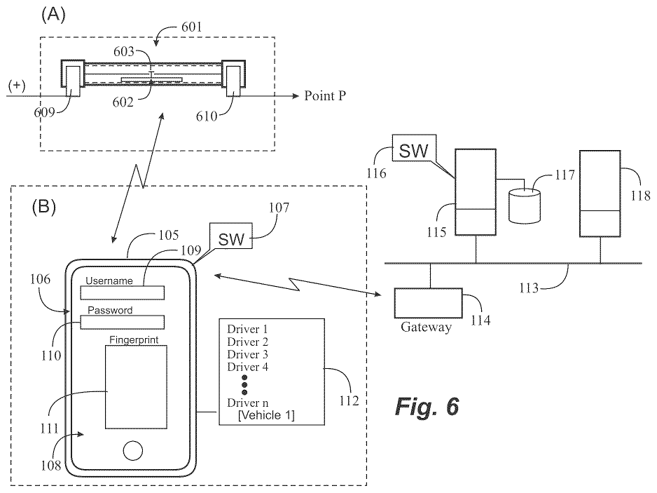

Taking into account that SmartFuse 501 need only be activated for a short duration during the starting sequence, in another embodiment, illustrated as FIG. 6, SmartFuse 601 need not have a fuse element, but only the function of portion 503 of FIG. 5. As the circuit of the SmartFuse is only closed for a very short time, there is really little need for a fuse element. In FIG. 6 SmartFuse 601 embodies just the On-Off function triggered by remote activation of N. O contact 603 by circuitry 602 that comprises the CPU, data repository and wireless communication circuitry, triggered by wireless command from portable device 105.

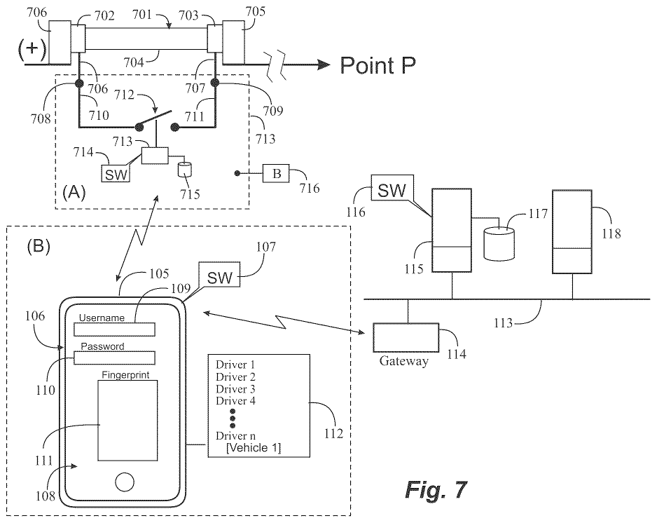

In some applications it may be that the volume and dimensions of the fusebox and fuse elements in the fusebox are too small to accommodate a SmartFuse as in FIG. 5 and FIG. 6. FIG. 7 illustrates another embodiment in which the functions of the SmartFuse are incorporated in a physical package 713 enclosing functional elements for opening and closing contact 712. In this embodiment a dummy fuse 701 with contact ends 702 and 703 is of the dimensions of the standard fuse, by body 704 has no conductive element. Instead package 713 has an input terminal 708 and an output terminal 709 connected by wires 706 and 707 respectively to ends 702 and 703 of the dummy fuse. Terminals 708 and 709 connect by conductors 710 and 711 to terminals of N.O. contact 712, which is operated by CPU 713, executing SW 714, in response to remote signal by wireless communication circuitry from portable device 105. The operation of device 105 is as described above for FIGS. 5 and 6.

In this embodiment the user is provided with a package including package 713 connected to dummy fuse 701. The user may remove the appropriate fuse in the fuse box and replace it with the dummy fuse connected to package 713. Package 713 may just hang out of the fuse box, or may be mounted close by, or may just reside on top of the fuse box.

Contact end 702 is powered by voltage from the vehicle battery by clip 706. Contact end 703 provides voltage to clip 705 when contact 712 closes, providing power to point P, which, as described above may be any one of elements that must have power for the starting sequence to occur, such as, for example, a relay providing power to the starter solenoid.

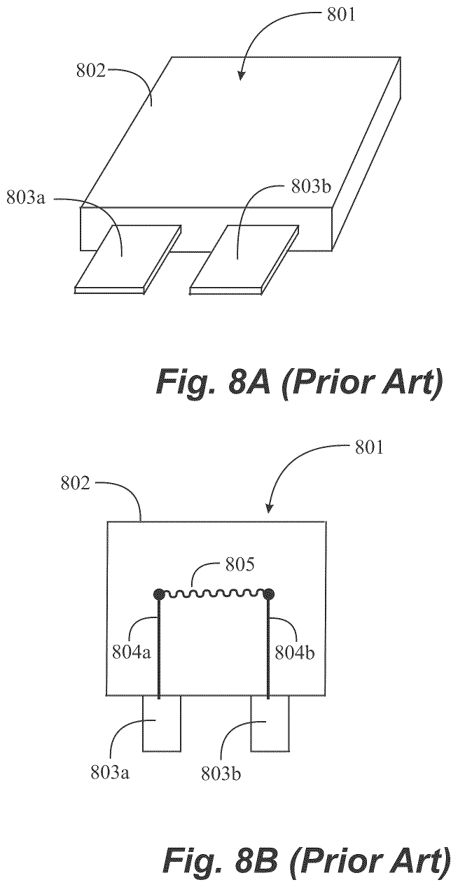

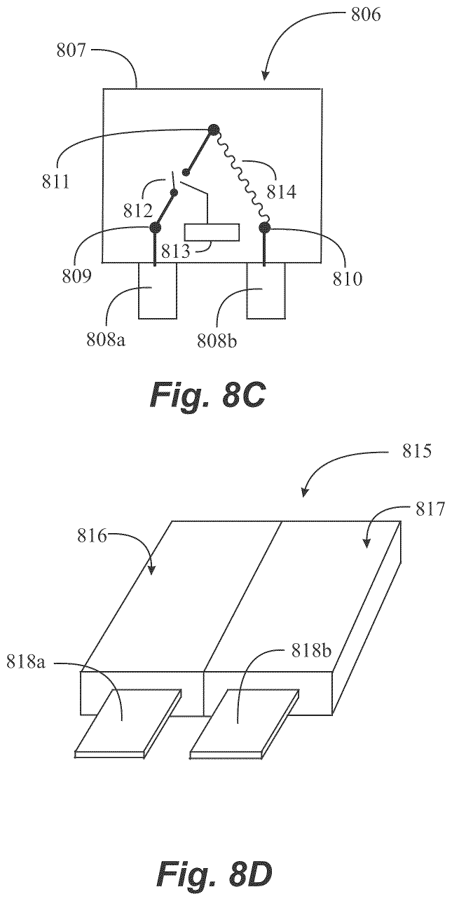

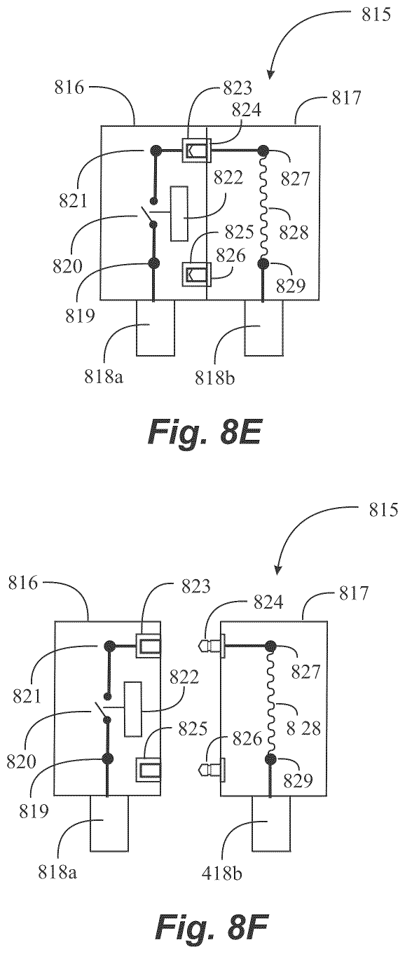

In the embodiment illustrated in FIGS. 5, 6 and 7 the compound SmartFuse replaces a cylindrical fuse in a fuse box typically associated with older automobiles and other vehicles. More modern automobiles typically have a fuse box, usually under the hood of the automobile, sometimes called a fuse and relay center, that incorporates fuses and relays that plug into an electrical board by spade connectors. FIG. 8A illustrates a conventional fuse 801 in a form factor to be used with such a more modern fuse and relay center. In the conventional fuse a body 802 has extending blade contacts 803a and 803b that are adapted to plug into blade sockets in the fuse and relay center.

FIG. 8B illustrates fuse 801 of FIG. 8A opened to show internal components. Conductors 804a and 804b extend from blades 803a and 803b in the fuse, and a fuse filament 805 is connected across the conductors, such that current to whatever component in the automobile is powered by fuse 801 passes through the filament. The filament is sized such that a current over a specific current will cause the filament to burn out, and the circuit will open. The skilled person will understand that the depiction is representative, and that different fuses may be implemented in different ways to provide the function of creating an open circuit when encountering a current at the threshold value for failure.

FIG. 8C illustrates a SmartFuse 806 according to an embodiment of the invention, wherein the SmartFuse powers a starter relay that in turn operates a starter solenoid. SmartFuse 806 has a body 807 with blades 808a and 808b, which are connected to internal junction points 809 and 810 respectively. A remotely operable contact 812 is imposed in a conductor between junction point 809 and a central junction point 811. Electronics 813 comprise a processor, such as a microprocessor, a data repository, coded instructions (Software) and wireless communication circuitry that are adapted to open and close contact 812 when signaled remotely from a portable communication device, such as device 102 described above. The electronics and switch 812 may be implemented as a printed circuit board with the switch comprising such as a MOSFET device. The skilled person will understand that there are a variety of ways that the necessary functions may be implemented by solid state devices.

A fuse filament 814 is implemented between central junction point 811 and junction point 810, such that in operation with switch element 812 closed the fuse filament protects the device powered by the SmartFuse.

In the format depicted by FIG. 8C, when a subject interacts with one or more interactive interfaces displayed on display screen 103 of portable device 102 to qualify to start the vehicle, if the subject qualifies, the portable device sends a wireless signal to the SmartFuse, which closes contact 812 for a predetermined time, such as, for example, 15 seconds. The subject turns the key switch or presses the start button, and the car will start. After the predetermined time the switch opens, but the car will continue to run. If the subject stops the car and turns off the ignition, the process must be repeated to start the automobile again.

The skilled person will understand that in the format of FIG. 8C, if the fuse filament blows, the fuse must be removed and replaced, and the electronic elements of the SmartFuse are lost as well.

In an alternative embodiment a SmartFuse is provided wherein the SmartFuse is a compound device with the functions of the fuse filament and the switching element separated. FIG. 8D illustrates a SmartFuse 815 comprising a first body 816 and a second body 817. Body 816 comprises the electronics and switching elements, and body 817 comprises the fuse elements. Body 816 has a blade contact 818a and body 817 has a blade contact 818b.

FIG. 8E illustrates separable SmartFuse 815 showing internal elements. Body 816 has a junction point 819 connected by a conductor to blade contact 818a. A contact 820 is implemented in a conductor between junction point 819 and another junction point 821. The contact is controlled by electronics 822 that comprise the processor, data repository, software and wireless communication circuitry. Junction point 821 connects to a receptacle 823 which engages with a plug 824 in body 817. Plug 824 connects to a junction point 827 in body 817. A fuse filament, or equivalent element, connects between junction point 827 and anther junction point 829 that connects to blade contact 818b. A second plug and socket comprising plug 826 and socket 825 is provided to ensure a secure engagement of body 816 and 817.

FIG. 8F illustrates body 816 disconnected from body 817. The element numbers and parts are the same as described above for FIG. 8E. When and if fuse filament, or equivalent, 828 blows, a user may remove the compound SmartFuse from its engagement in the fuse and relay center, and may separate body 816 from body 817. Body 817 may be discarded and replaced and the new body 817 plugged into body 816. This implementation saves the electronics and switching elements.

In another aspect of the invention, for vehicles and other apparatus that use key fobs, the key fob may in several ways be utilized in policing who may (or may not) operate a vehicle or other apparatus enabled by a key fob. The inventor terms this innovation a “smart fob”.

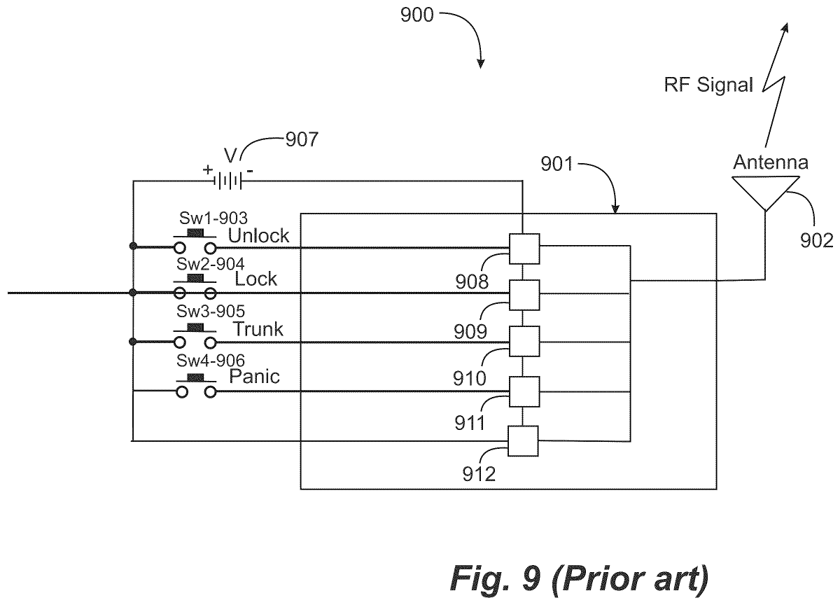

FIG. 9 is a generalized diagram of a key fob 900 in the prior art as may be utilized with a vehicle for such as unlocking doors and enabling a pushbutton to start the engine of the vehicle. The functions of a key fob may be implemented in a number of different ways by differing circuitry, and many different forms of key fobs are used and provided by different automobile manufacturers, but the key fobs generally perform the same functions in different automobiles and other vehicles. Key fob 900 in this generalized diagram has a battery 907, which in many systems is a 3V battery, sometimes a CR 2032 battery. Positive voltage is applied to signal-generating elements through a set of switches, four in this example, and to one signal generator 912 directly. The negative terminal of the battery is shown in FIG. 9 leading to elements generating signals, and is connected within the body as necessary to provide a ground connection for all elements requiring power.

Signal generator 912 provides an encrypted signal at a specific frequency, in this example and many other instances 315 Mhz in the USA and Japan, but may differ in Europe and in other jurisdictions. The signal from generator 912 does not require a pushbutton in this example and is emitted continuously when the generator is powered. This is the signal by which the automobile's computer system recognizes the key fob is present, and when received enables the starter pushbutton, typically on the vehicle's dashboard, to power the starter circuit, typically in concert with one or more other inputs, such as the brake pedal being depressed.

There are four pushbutton switches Sw 1 through Sw 4 in the key fob circuitry illustrated in FIG. 9 . . . Sw 1 (903) when pressed activates a signal generator 908 that sends an encrypted signal via a specific frequency via an antenna 902, that the vehicle's computer system may recognize and cause to unlock doors of the vehicle. Sw 2 (904) when pressed activates a signal generator 909 that sends an encrypted signal via a specific frequency via antenna 902, that the vehicle's computer system may recognize and cause to lock doors of the vehicle. Sw 3 (905) when pressed activates a signal generator 910 that sends an encrypted signal via a specific frequency via antenna 902, that the vehicle's computer system may recognize and cause to unlock the trunk of the vehicle. Sw 4 (906) when pressed activates a signal generator 911 that sends an encrypted signal via a specific frequency via antenna 902, that the vehicle's computer system may recognize and activate a panic mode, that may include audio signals like the horn honking.

As described, above generator 912 generates a continuous encrypted signal that, when the key fob is in range, the vehicle's computer system may recognize as a key fob is present and enable the starter pushbutton to start the vehicle.

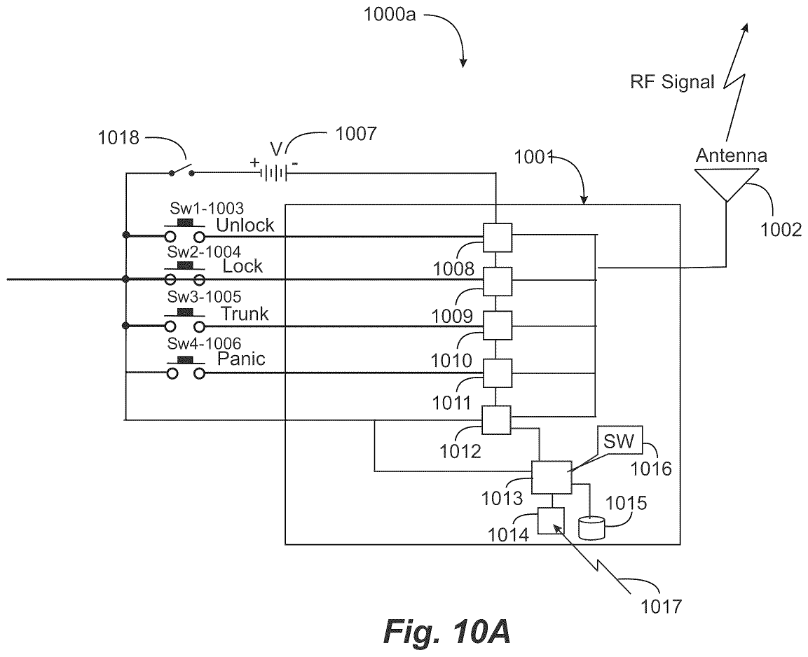

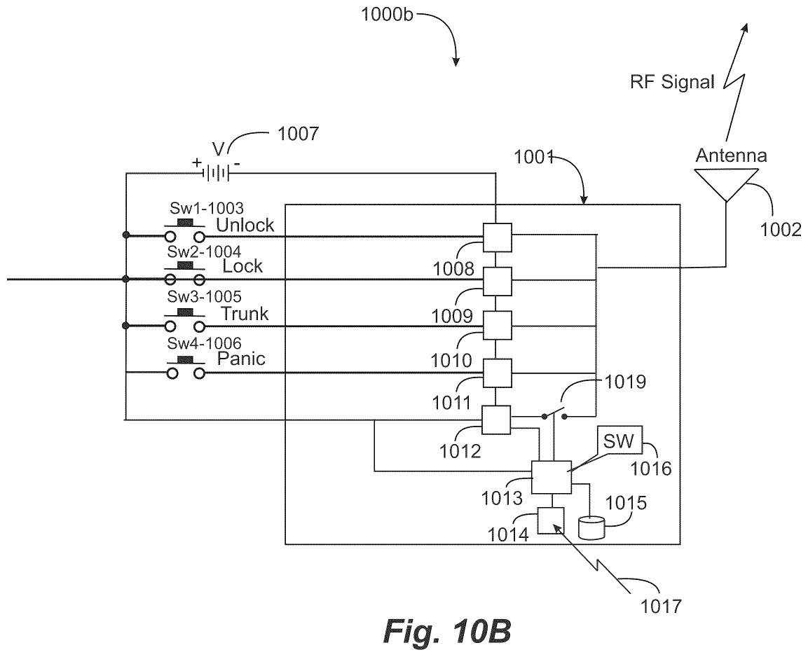

FIG. 10A illustrates a key fob 1000a in an embodiment of the present invention that may be utilized to prevent the vehicle from starting if the potential driver is not an authorized driver for the vehicle, or, in another aspect, may be impaired. In key fob 1000a a microprocessor 1013 executes software (SW) 1016 from a data repository 1015 and controls a remotely operable, normally open (NO) switch 1018 in a conductor from the positive terminal of battery 1007. Switch 1018 being NO ensures the key fob is not operable until and unless a signal 1017 from a portable device not shown in FIG. 10 is received via wireless communication circuitry 1014.

FIG. 10B illustrates a key fob 1000b in an embodiment of the present invention that may be utilized to prevent the vehicle from starting if the potential driver is not an authorized driver for the vehicle, or, in another aspect, may be impaired. In key fob 1000b a microprocessor 1013 executes software (SW) 1016 from a data repository 1015 and controls a remotely operable, normally open (NO) switch 1019 in a conductor from generator 1012. Switch 1019 being NO ensures the “fob present” signal is not transmitted until and unless a signal 1017 from a portable device not shown in FIG. 10 is received via wireless communication circuitry 1014.

In key fobs 1000a and 1000b data repository 1015 may be used to store data in addition to SW to be executed by microprocessor 1013. One such piece of data may be the VIN of the vehicle to which the key fob is associated, or another unique ID of the specific vehicle. This storage may be done at time of manufacture of the key fob, or more likely introduced in a process of associating a generic key fob of the sort of element 1000a or 1000b with a specific vehicle. At time of use it is necessary that the vehicle unique identification be accessible from the key fob.

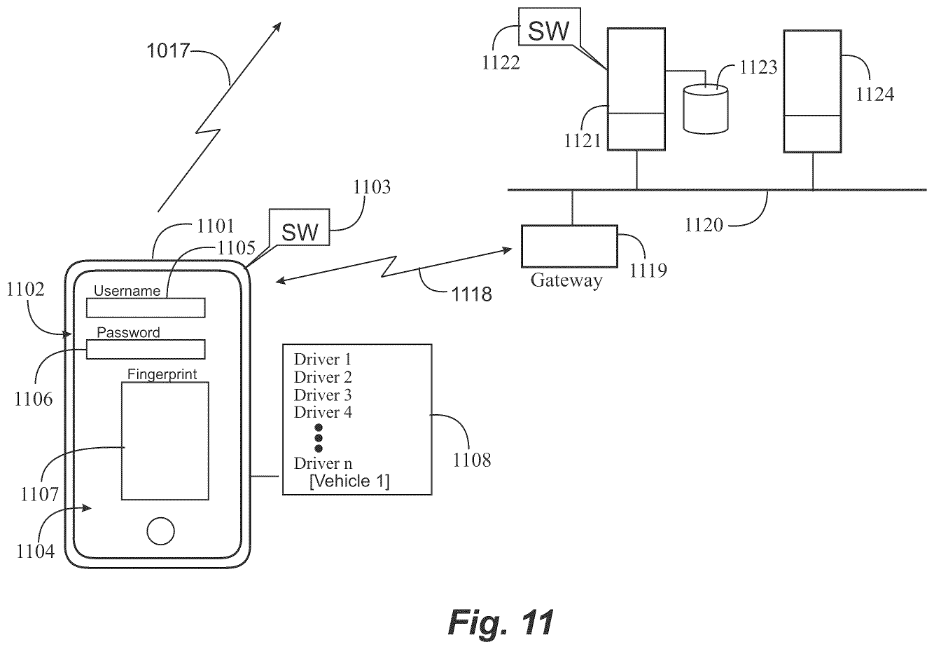

FIG. 11 is a diagram of a mobile device 1101, in this example a smartphone, executing a mobile application 1103 that provides an interactive interface 1104 on a display 1102 of the smartphone. Interactive interface 1104 comprises an entry field 1105 for a username, an entry field 1106 for a password and optionally a biometric input like a fingerprint scanner 1107 or an equivalent authentication mechanism. To start and operate a vehicle protected by a key fob 1000 according to an embodiment of the invention a candidate driver must have a smartphone executing application 1103 and must log in to the app via the input fields or other means provided in interactive interface 1104. Any person attempting to start the vehicle must of course have the key fob and, if aware of the circumstances, will know to boot the app (if not already executing) and log in. Otherwise the candidate cannot start the vehicle.

The candidate driver having key fob 1000 may enter the vehicle and log into mobile app 1103. Of course, the candidate may have booted the app and logged in prior to entering the vehicle. App 1103 after log in communicates wirelessly with key fob 1000 through wireless communication circuitry 1014 and accesses and copies the unique identification stored in data store 1015. App 1103 communicates through gateway 1119 with server 1121 in the well-known Internet network, providing the ID of the vehicle, and server 1121 provides a list 1108 of drivers approved to operate the subject vehicle. App 1103 may peruse list 1108 online at server 1121, or the list may be downloaded to smartphone 1101.

Once list 1108 is available app 1103 checks for the candidate driver's ID in the list, and if the ID is not in the list the process ends and the candidate driver cannot start the vehicle. If the candidate driver's ID is found in list 1108 app 1103 sends a wireless signal 1017 through wireless communication circuitry 1014 to microprocessor 1013 to close switch 1018, which enables the encrypted signal generated by signal generator 1012 to be sent via antenna 1002 to the vehicle's computer system enabling the starter pushbutton to energize the starter circuitry and start the vehicle.

The embodiment described here wherein lists of approved drivers may be checked to authorize a candidate driver is useful for such as commercial enterprises in which fleets of vehicles are utilized by a large plurality of persons employed as drivers, such as delivery services, overland hauling companies, taxi services and more. It is serviceable as well for instances in which, for example, a family may be concerned about a senior family member that may not agree that driving ability is diminishing.

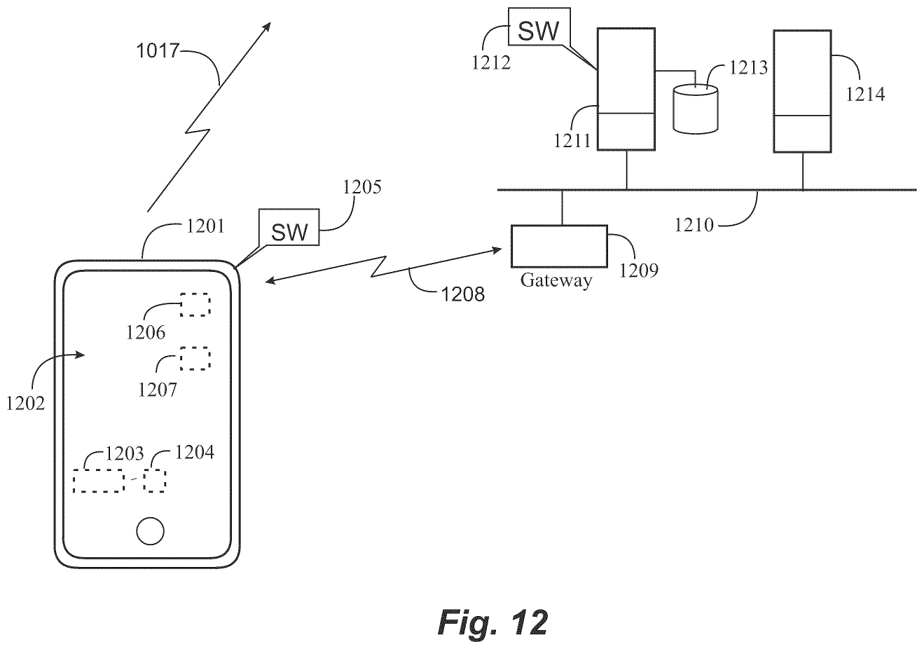

In another embodiment of the invention the system with a smart key fob is useful for real-time testing of a candidate driver's physical impairment at the time of attempting to start a vehicle and preventing the candidate from operating the vehicle if he or she is physically impaired. FIG. 12 is a diagram of a mobile device 1201, in this example a smartphone, executing a mobile application 1205 that provides an interactive interface on a display 1202 of the smartphone.

In one embodiment device 1201 with a display 1202 executes by a CPU 1203 a mobile application 1205. Device 1202 also has a digital memory 1204, as well as a microphone 1206 and a speaker 1207. Device 1201 also in one embodiment communicates via a cellular network, or alternatively a WiFi and the well-known Internet network via path 1208 with a gateway 1209 by which the device connects to an Internet backbone 1210, representing all of the network and subnetwork connections in the Internet network. Communication may be with a server 1211 executing software 1212 and having a coupled data repository 1213. Communication may also be made with a server 1214.

It is well-known in the art to pair a breathalyzer interoperable with ignition circuitry to prevent a vehicle from starting, such that a person has to exhibit a low alcohol level for the vehicle to start. In embodiments of the present invention alcohol level in breath or otherwise might not be measured. The inventive system rather relies in some embodiments on testing behavior that may be altered by drug, alcohol, medical or psychological impairment.

In embodiments of the invention device 1201 may communicate with server 1211 on line and server 1211 provides tests for impairment, which may involve illustrated text and/or images and spoken audio. Such tests may be downloaded to memory in the smartphone. It is important in some embodiments for the tests to operate directly on the smartphone, because some tests are time sensitive, and delay from Internet communication would adversely affect the tests.

Application 1205 may display one or more interactive interfaces on display 1202, which may be a touchscreen display. It is well known that reaction time may be affected by different sorts of impairment. A simple test may be conducted by device 1201 in which an icon or other image may be projected onto display 1202 and the candidate may be expected to touch the screen in a certain way in response. The system measures the time interval in which the user responds. For example, the user may be instructed in an interactive interface that an image will be projected that is an arrow pointing in a certain direction, and the user is expected to swipe the screen in that direction as quicky as he or she may do so. The system notes the correspondence of the direction of the swipe with the arrow presented, as well as the time delay. Pass/Fail may depend on statistical archives of responses of people known to be unimpaired and people known to be impaired. Passing a test results in device 1201 sending signal 1017 to cause the smart fob to close the contact to enable the pushbutton start switch.

Another Pass/Fail test that may be imposed is a reading and enunciation test. The system may inform the user that a text passage will be posted, and the user is asked to recite the passage verbally. The clarity, enunciation and timing of the user's verbal response may indicate level of (or absence of) impairment. The user's response may be compared to results archived for the same test performed by persons known to be impaired or unimpaired. In some circumstances two or more Pass responses may be required for a Pass signal to be sent from device 1201 to the smart key fob.

In one embodiment mobile application 105 may be provided by server 1211, which may be hosted by law enforcement or by a judicial system. In a court required application of system a system according to an embodiment of the present invention, as a result perhaps, of conviction for a DUI or another circumstance, performance of the person required to use the system may be recorded and archived, so the judicial or law enforcement host will have records of performance. In one embodiment the smart key fob component may be installed by a registered and authorized service, and the user may not know where the device is installed or how it operates.

Further, in one embodiment, records of performance of specific tests may be maintained for specific persons, providing baseline data for comparison to real-time performance. For example, a person found guilty of a DUI, wherein a court may require installation of a device according to an embodiment of the present invention, may further be required to perform the tests enabled on the mobile device executing the mobile app in an embodiment of the invention, in an unimpaired state, to be recorded as a baseline for comparison to later test results, and the baseline results may be stored in a database hosted by the court, which database may be queried by the mobile app. through the Internet connection.

In some embodiments the system may employ an accelerometer senser-A method and system to collect and store monitoring human activity using an inertial sensor or accelerometer walking patterns for future comparisons. Also, in some embodiments the system may employ a Heat/Temperature Sensor—There may be a method to collect an individual's temperature data over time, correlating user normal temperature data to determine the possibility of impaired abilities compared to a normal state. There may be a heart-beat Sensor/Pulse Sensor and a method to collect heartbeat signals to store for future comparisons. There may be a Proximity/GPS Sensor and a method to collect user location data over time, correlating user location data with known locations of the possibility of impaired abilities compared to a normal state. There may be a Gyroscope and a method and system to collect and store movements to determine average movements for future comparisons. There may be Eye Recognition (iris) and a method to capture normal dilation for future comparisons. There may also be an ambient light sensor.

Incorporated with server 106 or 109 there may further be a sub-system for reception, accumulation, comparison, and transmission, of data, such as:
Location Database—finds and stores geographic data where the smart device is located and matches it with different known geolocating maps. The system will force a series of tests if the location is a known location for drug or alcohol use.
Sensor Database—Stores data from the different sensor input
Voice Database—Stores an individual's voice so that it can compare the voice for future evaluations.
History Database—Stores data from different sources such as DMV, Insurance, etc. of past events.
Contributor Database—Stores list of a contributors that may have input into the evaluation criteria.
Third Party Data—storage of data from third parties that can be useful for decision-making, analysis, and comparisons.
Event Database—contains information such as the date and time of the event, the location, and other relevant details for comparison.
Approved driver database/Authorization and permissions Database—stores information about the different roles, privileges, and permissions that users have within the system.
Time Database—to store and manage time-related data, such as dates, times, time zones, and time intervals for vehicles and users.

### Additional System Input Mechanisms

Input Speed—Timed measurements to tap objects on the device for future comparisons. An individual can be impaired due to the effects of alcohol or drugs on their motor coordination, reaction time, and cognitive abilities.
Speech—Times measurement of recorder words for future comparisons by capturing and processing the data recognizing speech patterns and accurately converting them into text or other types of data for comparisons.
Camera—captures images or video, to process the data and uses it as input for various applications comparisons.
Vehicle—Multiple vehicle inputs can be captured using a variety of technologies, including GPS tracking devices, telematics systems, and onboard vehicle sensors. This data can then be transmitted wirelessly to a central server, where it can be processed and analyzed including include a variety of information about the vehicles, such as their location, speed, direction, fuel levels, engine performance, and more.
Sensor—devices that are designed to measure or detect various physical parameters, such as images, temperature, pressure, light, sound, or motion for future comparisons.
Biometric—unique physical or behavioral characteristics, such as fingerprints, facial features, iris patterns, or voiceprints. This data can then be used for identification, authentication, access control purposes, and future comparisons.
Third-party data generated by individuals or organizations that are not directly involved in the system or process but provide relevant information that can be useful for decision-making or analysis.

In one embodiment the system works in a flow as follows:
(a) User initiates a test to approve the operation of the vehicle.
(b) The system determines the best data to initiate a first test based on sensors or statistical data available to the system.
(c) The best test for an evaluation is started.
   If results are unclear—a second more difficult test is started. OR
   If the results are unclear a different test is started.
Don't pass tests—the vehicle is not approved to operate.
Pass the test—the vehicle is approved to operate.

In the various operations different sensors and methods may be queried to perform the needed functions.

Other systems that may be used in different embodiments include:
Behavioral Analysis Module: Utilizes machine learning algorithms to analyze the behavior patterns of the operations of the vehicle and predict potential unauthorized use or impairment based on deviations from the norm. This could work in tandem with the Sensor and History Databases to provide a more nuanced understanding of the driver's condition.
Real-time Monitoring and Alert System: This system would actively monitor vehicle operation and driver status, sending alerts to relevant parties (such as law enforcement or emergency contacts) if it detects unauthorized use or conditions that suggest the driver is under the influence or otherwise impaired.
Feedback Loop for Continuous Improvement: Incorporating a mechanism for analyzing incidents, breaches, or false positives/negatives to refine the evaluation criteria, improve database accuracy, and update security measures. This would involve machine learning and data analytics to adjust to new patterns of behavior, emerging threats, or changes in user status.

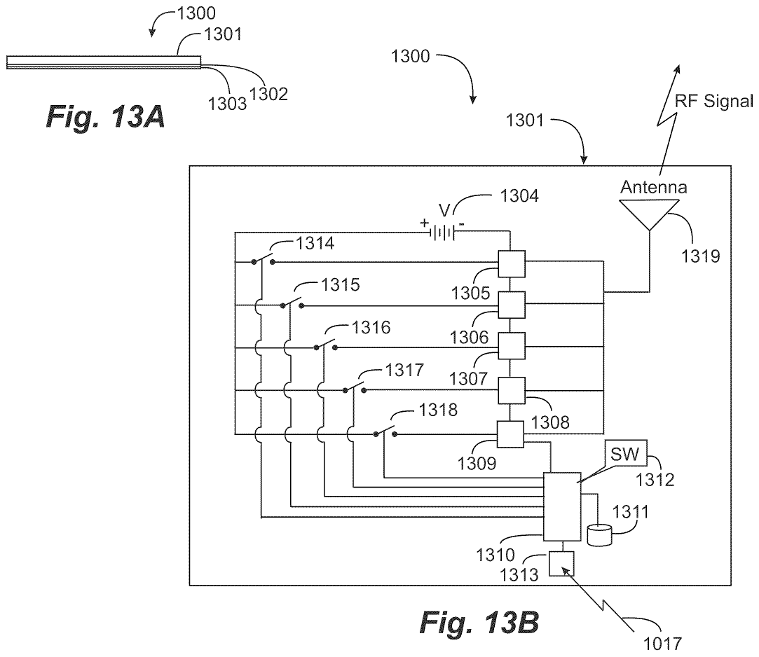

In another aspect and embodiment of the invention a stationary key fob is provided that may be placed in or on the vehicle to which it is paired and may be operated by the mobile app executed by a candidate driver's smartphone in a variety of modes. FIG. 13A is a side elevation view of a specialized key fob 1300 in an embodiment of the invention, comprising fob elements in an enclosure 1301 with an adhesive layer 1302 on one side covered by a plastic peel-off sheet 1303.

FIG. 13B is a plan view of enclosure 1301 shown opened to illustrate elements within the enclosure. There is a battery 1304 powering electronic elements of the device, which is, as described above, in this example a 3V CR 2032 battery. There are, in the device in this example, five signal generators. Signal generator 1305 generates a signal for unlocking doors of the subject vehicle. Signal generator 1306 generates a signal for locking doors of the subject vehicle. Signal generator 1307 generates a signal for unlocking the trunk of the subject vehicle. Signal generator 1308 generates a signal for a panic mode wherein the horn may honk and other alerts may be activated. Signal generator 1309 generates a signal that the computer system of the subject vehicle recognizes as a key fob is present and enables the starter push button to start the vehicle when depressed. The signal generators are all coupled to an antenna 1319 that transmits a wireless signal from any generator active.

A microprocessor 1310 coupled to a data repository 1311 executes SW 1312 from the data repository. A wireless communication circuit 1313 is coupled to the microprocessor. In manufacture or in a pairing procedure the VIN of the vehicle associated with key fob 1300 or another unique identification is stored in data repository 1311

In one embodiment specialized key fob 1300 may be mounted to a surface of a subject vehicle by peeling peel-off sheet 1303 from adhesive layer 1302 and pressing the body 1301 to the surface. This may be anywhere in or on the vehicle withing broadcast range of the vehicle's computer system. It may be mounted, for example, to the dashboard or under the dashboard or to a center console. If preferred it may be just placed in the glove compartment or another pocket or receptacle, but the user should remember where it is, as there may be occasion to find it to replace the battery or for some other purpose.

Once the specialized key fob 1300 is physically placed in or on the vehicle, all functions may be initiated and controlled by the driver's smartphone. Referring back to FIG. 11 the candidate driver has a smartphone 1101 with a stored mobile application 1103. The candidate driver must boot the mobile app on his or her smartphone and log in. Once logged in the mobile app retrieves the VIN or other unique ID of the vehicle and queries server 112 with the ID for a list of candidate driver authorized to operate the vehicle, in one embodiment, or for tests to pass in the circumstance of checking for impairment. In some embodiments both functions may be served. If the candidate requires passing a test for impairment that fact will be inherent in the candidate's smartphone app or the app may query an online server for the information. In some cases the requirement may be programmed into data repository 1311. If the candidate requires tests for impairment that procedure is followed, otherwise the mobile app looks for the list of authorized drivers.

In the case of authorizing a candidate to operate the vehicle the mobile app checks the list retrieved or queried for the ID of the candidate driver, and if found sends signal 1017 via wireless circuitry 1313 to microprocessor 1310, and the microprocessor closes switch 1318 energizing generator 1309 to generate the encrypted signal that the vehicle's computer system recognizes as a fob is present, and the start push button is enabled, and the candidate mat start and drive the vehicle. In the case of test for impairment the mobile app follows the protocol described above referring to FIG. 12 to attempt to qualify the candidate to operate the vehicle.

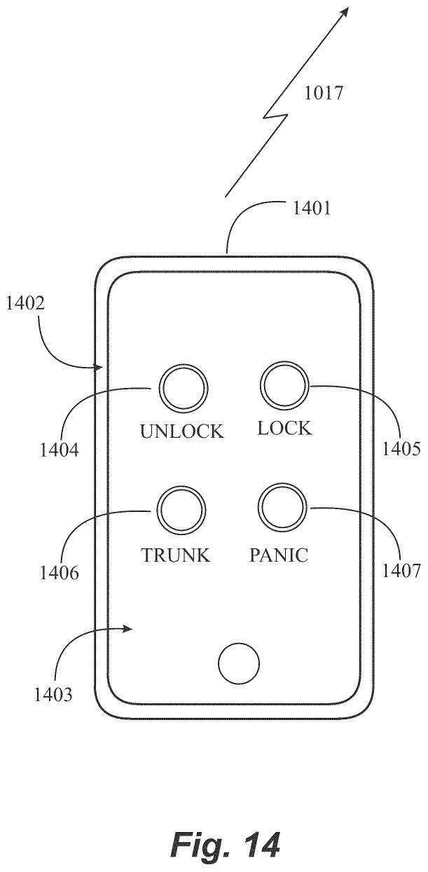

The candidate driver will understand, knowing the vehicle is so equipped, that the mobile app may be engaged and executing before the candidate attempts to enter the vehicle. Thus the identification and authorization may be accomplished before entry. FIG. 14 is a diagram of an interactive interface that may be displayed immediately after the candidate driver is identified as on the list of authorized drivers and the starter push button is activated. Smartphone 1401 has a touchscreen display 1402. An interactive interface 1403 is displayed having four virtual push buttons. PB 1404 when pushed (touched) sends a signal 1017 to microprocessor 1310 via circuit 1313 to close switch 1314 to signal the vehicle computer to lock the doors. PB 1405 when pushed (touched) sends a signal 1017 to microprocessor 1310 via circuit 1313 to close switch 1315 to signal the vehicle computer to unlock the doors. PB 1406 when pushed (touched) sends a signal 1017 to microprocessor 1310 via circuit 1313 to close switch 1316 to signal the vehicle computer to unlock the trunk. PB 1474 when pushed (touched) sends a signal 1017 to microprocessor 1310 via circuit 1313 to close switch 1317 to signal the vehicle to enter Panic mode.

The skilled person will understand that the interactive display may be organized differently or in a different order, and that there may be a variety of other functions enabled. In another embodiment the mobile app may be configured for voice activation and the candidate may initiate functions by voice command.

The skilled artisan will understand that the embodiments illustrated and described above are exemplary only, and might be implemented with somewhat different elements that provide equivalent functionality. The elements in the fuses that open may not be wire filaments for example. The invention is limited only by the scope of the claims.

1. A system for enabling a candidate driver to start a vehicle, comprising:
a key fob comprising a plurality of signal generators each coupled to a common antenna and configured to generate an encrypted RF signal at a specific frequency, one of the encrypted signals being a signal recognizable by the vehicle's computer system as presence of the key fob, the generators, except the generator providing the signal recognizable by the vehicle's computer system as presence of the key fob, powered from a common battery through individual dedicated normally-open (NO) switches, a microprocessor executing first coded instructions from a data repository coupled to the microprocessor, wireless communication circuitry coupled to the microprocessor; and a (NO) remotely-operable switch positioned in the circuitry in a manner that prevents, when open, generation of the encrypted signal indicating presence of the key fob; and
a smartphone executing a mobile application generating an interactive interface on a touchscreen display of the smartphone at least enabling a candidate driver to log in to the mobile application;
wherein the candidate driver logs in to the mobile application, the mobile application determines if the candidate driver is authorized to start and operate the vehicle, and if so, transmits a signal to the microprocessor via the wireless communication circuitry, causing the microprocessor to close the NO remotely-operable switch positioned in a manner to prevent, when open, generation of the encrypted signal indicating presence of the key fob, closing the switch signaling the vehicle's computer system to enable the starter pushbutton such that the candidate driver may start the vehicle.

2. The system of claim 1 wherein the individual, dedicated NO switches to individual generators are physical push button switches, the NO remotely-operable switch positioned in a manner to prevent, when open, generation of the encrypted signal indicating presence of the key fob, is positioned in a conductor from a positive terminal of the battery, such that, when open no elements are powered, and when closed by the microprocessor the pushbutton switches are powered, the encrypted signal indicating presence of the key fob is powered, and the candidate driver may individually activate any one of the generators powered through the pushbuttons.

3. The system of claim 1 wherein the individual, dedicated NO switches to individual generators are physical push button switches, the NO remotely-operable switch positioned in a manner to prevent, when open, generation of the encrypted signal indicating presence of the key fob, is positioned in a conductor between the generator of the encrypted signal indicating presence of the key fob and the antenna, such that when open the signal that a key fob is present is not transmitted, but the candidate driver may activate other signals through the physical pushbutton switches.

4. The system of claim 1 wherein the individual, dedicated NO switches to individual generators are remotely operable by the microprocessor, there are no physical pushbutton switches and all signal generation is initiated by the mobile app executing on the smartphone.

5. The system of claim 4 wherein the key fob is placed in the vehicle and is stationary, rather than being carried by the candidate driver.

6. The system of claim 4 wherein the key fob is a relatively flat enclosure holding the key fob elements, and has an adhesive on one side enabling the key fob to be mounted to a surface in or on the vehicle.

7. The system o claim 5 wherein the surface is on the vehicle's dashboard or a center console.

8. The system of claim 4 wherein the mobile app generates interactive interfaces on a touchscreen display of the smartphone, and one such display comprises virtual pushbuttons dedicated to sending signals to the microprocessor of the key fob causing individual ones of the remotely operable switches to close, such that the candidate driver, through interacting with the virtual pushbuttons in the display, causes locking and unlocking and other automobile functions to occur.

9. The system of claim 1 wherein determination of whether the candidate driver is authorized to start and operate the vehicle is accomplished by the mobile application administering tests to the candidate driver, determining of the candidate driver is impaired physically or mentally.

10. The system of claim 1 wherein determination of whether the candidate driver is authorized to start and operate the vehicle is accomplished by the mobile application checking to see if the candidate driver's identification is in a list of authorized candidate drivers for the specific vehicle.

11. The system of claim 10 wherein a list of authorized drivers is downloaded by the mobile application from an internet-connected server using a unique vehicle identification retrieved from the data repository coupled to the microprocessor in the key fob.

12. A method for enabling a candidate driver to start a vehicle, comprising:
providing a key fob comprising a plurality of signal generators each coupled to a common antenna and configured to generate an encrypted RF signal at a specific frequency, one of the encrypted signals being a signal recognizable by the vehicle's computer system as presence of the key fob, the generators, except the generator providing the signal recognizable by the vehicle's computer system as presence of the key fob, powered from a common battery through individual dedicated normally-open (NO) switches, a microprocessor executing first coded instructions from a data repository coupled to the microprocessor, wireless communication circuitry coupled to the microprocessor; and a (NO) remotely-operable switch positioned in the circuitry in a manner that prevents, when open, generation of the encrypted signal indicating presence of the key fob;
executing a mobile application on a smartphone, generating an interactive interface on a touchscreen display of the smartphone at least enabling a candidate driver to log in to the mobile application;
logging in to the mobile application by the candidate driver;
determining by the mobile application if the candidate driver is authorized to start and operate the vehicle; and
if it is determined the candidate driver is authorized, causing the microprocessor to close the NO remotely-operable switch positioned in a manner to prevent, when open, generation of the encrypted signal indicating presence of the key fob, closing the switch signaling the vehicle's computer system to enable the starter pushbutton such that the candidate driver may start the vehicle.

13. The method of claim 12 wherein the individual, dedicated NO switches to individual generators are physical push button switches, comprising positioning the NO remotely-operable switch positioned in a manner to prevent, when open, generation of the encrypted signal indicating presence of the key fob, in a conductor from a positive terminal of the battery, such that, when open, no elements are powered, and when closed by the microprocessor the pushbutton switches are powered, the encrypted signal indicating presence of the key fob is powered, and the candidate driver may individually activate any one of the generators powered through the pushbuttons.

14. The method of claim 12 wherein the individual, dedicated NO switches to individual generators are physical push button switches, comprising positioning the NO remotely-operable switch positioned in a manner to prevent, when open, generation of the encrypted signal indicating presence of the key fob, in a conductor between the generator of the encrypted signal indicating presence of the key fob and the antenna, such that when open the signal that a key fob is present is not transmitted, but the candidate driver may activate other signals through the physical pushbutton switches.

15. The method of claim 12 wherein the individual, dedicated NO switches to individual generators are remotely operable by the microprocessor, there being no physical pushbutton switches, comprising initiating all signal generation by the mobile app executing on the smartphone.

16. The method of claim 15 comprising placing the key fob stationary in the vehicle, rather than being carried by the candidate driver.

17. The method of claim 15 wherein the key fob is a relatively flat enclosure holding the key fob elements, and has an adhesive on one side, comprising mounting the key fob by the adhesive to a surface in or on the vehicle.

18. The method of claim 17 comprising mounting the key fob to the vehicle's dashboard or to a center console.

19. The method of claim 15 comprising the mobile app generating interactive interfaces on a touchscreen display of the smartphone, and one such display comprises virtual pushbuttons dedicated to sending signals to the microprocessor of the key fob causing individual ones of the remotely operable switches to close, such that the candidate driver, through interacting with the virtual pushbuttons in the display, causes locking and unlocking and other automobile functions to occur.

20. The method of claim 12 comprising determining whether the candidate driver is authorized to start and operate the vehicle is accomplished by administering by the mobile application tests to the candidate driver, determining of the candidate driver is impaired physically or mentally.

21. The method of claim 12 comprising determining whether the candidate driver is authorized to start and operate the vehicle by the mobile application checking to see if the candidate driver's identification is in a list of authorized candidate drivers for the specific vehicle.

22. The method of claim 21 comprising downloading a list of authorized drivers by the mobile application from an internet-connected server using a unique vehicle identification retrieved from the data repository coupled to the microprocessor in the key fob.
